(19) United States
(12) Patent Application Publication
(10) Pub. No.: US 2024/0109467 A1
(43) Pub. Date: Apr. 4, 2024

(54) SEAT CUSHIONS HAVING GRADIENT HARDNESS

(71) Applicant: Lear Corporation, Southfield, MI (US)

(72) Inventors: Abdulghani AL NABULSI, Oberding (DE); Frank STOEWESAND, Oberding (DE); Martin BAHNEMANN, Oberding (DE); Asad ALI, Troy, MI (US)

(73) Assignee: Lear Corporation, Southfield, MI (US)

(21) Appl. No.: 18/211,409

(22) Filed: Jun. 19, 2023

(30) Foreign Application Priority Data
Sep. 30, 2022 (DE) 10 2022 125 353.8

(51) Int. Cl. B60N 2/70

(52) U.S. Cl. CPC B60N 2/70

(57) ABSTRACT

Seat assemblies having one or more gradient foam cushions are disclosed. The foam cushions may have a continuous hardness, density, and/or deflection gradient such that a first end is softer and less dense than a second end. The foam cushion may be a single unitary piece of foam rather than layers of different foam material assembled together.

### CROSS-REFERENCE TO RELATED APPLICATION

This application claims foreign priority benefits under 35 U.S.C. § 119(a)-(d) to DE patent application 10 2022 125 353.8, filed Sep. 30, 2022, the disclosure of which is hereby incorporated by reference in its entirety.

### TECHNICAL FIELD

The present disclosure relates to seat assemblies having materials such as foam cushions for providing comfort to an occupant of the seat and methods thereof. More specifically, the present disclosure relates to simplifying multi-component assemblies while maintaining comfort.

### BACKGROUND

Traditionally topper pads have been used in seat assemblies to provide additional comfort to an occupant, as shown in FIG. 3. Seat assemblies are disclosed in U.S. Pat. No. 10,736,435 which issued to Lear Corporation on Aug. 11, 2020.

### SUMMARY

An embodiment of seat assembly for a vehicle is disclosed. The seat assembly includes a frame, a gradient foam cushion configured to be supported by the frame, and a trim cover configured for contact with an occupant. The trim cover is configured to be disposed over the gradient foam cushion. The gradient foam cushion has three zones (e.g., a first zone, a second zone, and a third zone) disposed between a first surface and a second surface. The first surface is proximate to the trim cover and the second surface is opposite the first surface. The first zone is adjacent to the first surface and the third zone is adjacent to the second surface such that the second zone is sandwiched between the first and third zones. The first zone has a lower hardness than the second zone which has a lower hardness than the third zone.

In some embodiments, the seat assembly has a hardness delta between the first and third zones of at least 1.0 kPa according to ISO 3386-1. For example, the first zone has a hardness of no more than 5.0 kPa according to ISO 3386-1 and the third zone has a hardness of at least 7.0 kPa according to ISO 3386-1. In at least one embodiment, the hardness of the second zone is at least 4.0 but no more than 6.0 kPa according to ISO 3386-1.

In one or more embodiments, the first zone has deflection that is more than the deflection of the second and the second zone has a deflection that is more than the third zone (i.e., the second zone has a deflection that is less than the first zone and the third zone has a deflection that is less than the second zone) according to ASTM D3574 or ISO 2439. For example, the difference in deflection between the first and third zone is at least 20% at a stress of 5 kPa. In a refinement, the first zone has a deflection of greater than 40% at 5 kPa. In yet another embodiment, the deflection of the first zone at 10 kPa is greater than 60% while the deflection of the third zone (at 10 kPa) is less than 60%.

In a refinement, the gradient foam cushion has a hysteresis loss of at least 23.5% according to ASTM D3574-17 test N using procedure B.

In a variation, the gradient foam cushion is a polyurethane foam cushion.

In another embodiment, a seat assembly is disclosed. The seat assembly includes a frame, a cushion configured to be supported by the frame, and a trim cover configured to be disposed over the cushion and frame. The cushion has a continuous density gradient from a first end to a second end such that the first end has a lower density than the second end. The first end is configured to be arranged more proximate to the occupant than the second.

In a variation, the continuous density gradient is defined by a difference of at least 5.0 kg/m³ according to ISO 845. In a refinement, the continuous density gradient is defined by a difference of at least 7.5 kg/m³. For example, a first volume of the cushion has a density of 60.0 to 66.0 kg/m³, a second volume of the cushion has a density of 64.0 to 71.0 kg/m³, and a third volume of the cushion has a density of 69 to 81 kg/m³. The first volume is adjacent to a first surface of the cushion and the third volume is adjacent to a second surface opposite the first surface such that the second volume is sandwiched between the first and third volumes.

In still another embodiment, a gradient foam cushion for a vehicle seat is disclosed. The vehicle seat includes a seat back and a seat bottom. The gradient foam cushion is arranged as a portion of the seat back and/or seat bottom. The gradient foam cushion is a polyurethane foam cushion having a first region, a second region and a third region. The third region has a higher hardness than the second zone which has a higher hardness than the first region. The first region is configured to be arranged more proximate to a seated occupant and the second region is sandwiched between the first and third regions.

In a variation, each region has thickness of between 10 and 40 mm. In a refinement, the first region has a hardness of no more than 5.0 kPa and/or the third region has a hardness of at least 7.0 kPa. In yet another refinement, the difference in deflection between the first region and the third region is at least 10% at a stress of 5 kPa.

### BRIEF DESCRIPTION OF THE DRAWINGS

FIG. 1 is a perspective view of a seat assembly showing a cross-sectional view of the trim cover and foam cushion.

FIG. 2 is a schematic cross-sectional view of an embodiment of a cushion having a gradient.

FIG. 3 is a cross-sectional view of a conventional seat assembly having a topper pad.

FIG. 4 is a cross-sectional view of another embodiment of a gradient cushion.

FIG. 5 is a cross-sectional schematic of yet another seat bottom gradient cushion.

FIG. 6 is a schematic cross-sectional view of another embodiment of a cushion having a gradient.

FIG. 7 is a deflection profile depicting three zones of the embodiment of FIG. 2.

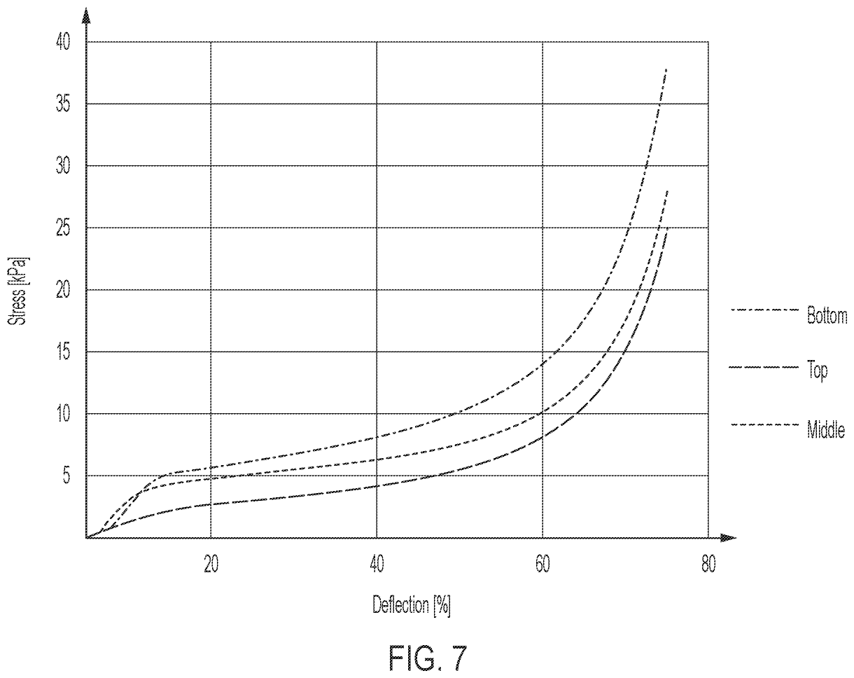

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for given purpose implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

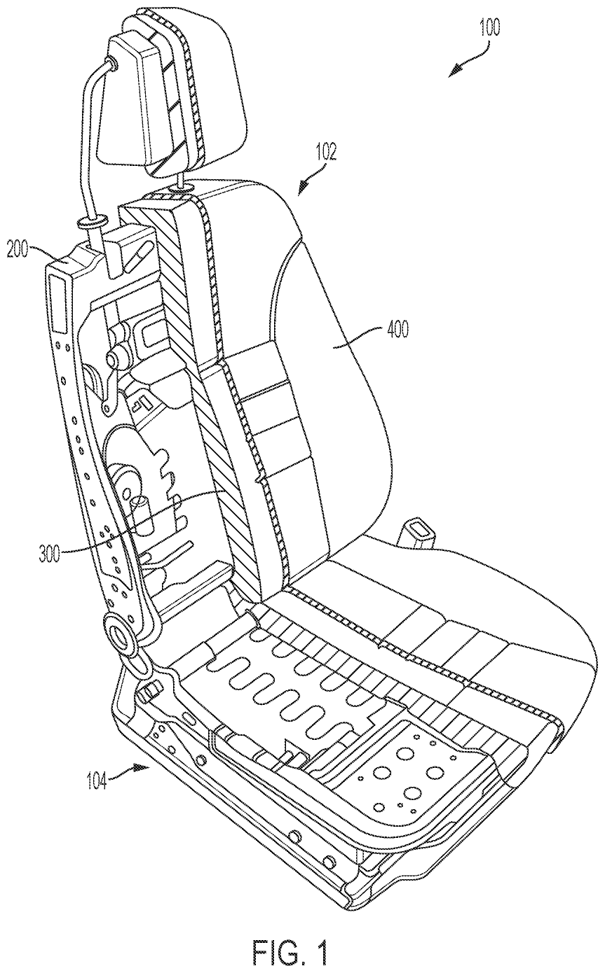

Referring to the embodiment of FIG. 1, a seat assembly 100 for a vehicle is disclosed. In one or more embodiments, the assembly 100 includes a seat frame 200 configured to support a gradient foam cushion 300 and a trim cover 400 disposed over the gradient foam cushion. The frame 200, gradient foam cushion 300, and trim cover 400 form a seat back 102 and/or a seat bottom 104 of the seat assembly 100.

In a variation, the seat frame 200 is made of rigid material such as metal or plastic. In a refinement, the seat frame 200 supports the foam cushion 300, other seat assemblies (e.g., massaging assembly, ventilation assembly, electronic components), and/or an occupant. For example, an aluminum seat frame 200 is used.

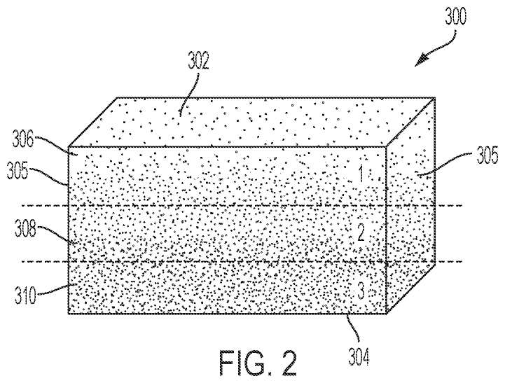

In some embodiments, the gradient foam cushion 300 is a cushion for the seat back 102 and/or the seat bottom 104. In various embodiments, the gradient foam may be used for various industrial and consumer applications. In automobiles, for example, several foam assemblies and components, including but not limited to seat cushions and vehicle interior components such as headrests and armrests may benefit from a gradient foam. In at least one embodiment, the gradient foam cushion 300 has a continuous hardness and/or density gradient, as schematically shown via shading in FIG. 2. In a variation, the gradient foam cushion 300 is any suitable material for forming a continuous gradient foam such as but not limited to a polyurethane foam. In a refinement, the gradient foam cushion 300 includes a first outer surface 302 at a first end configured to be proximate to the trim cover 400 and a second outer surface 304 at a second end opposite the first outer surface 302. In one or more embodiments, an intermediate or bulk portion is disposed therebetween (i.e., between the first and second surfaces 302, 304). In a variation, the second end has a greater hardness and/or density than the first end. In a refinement, the intermediate portion has a hardness and/or density between that of the first and second ends.

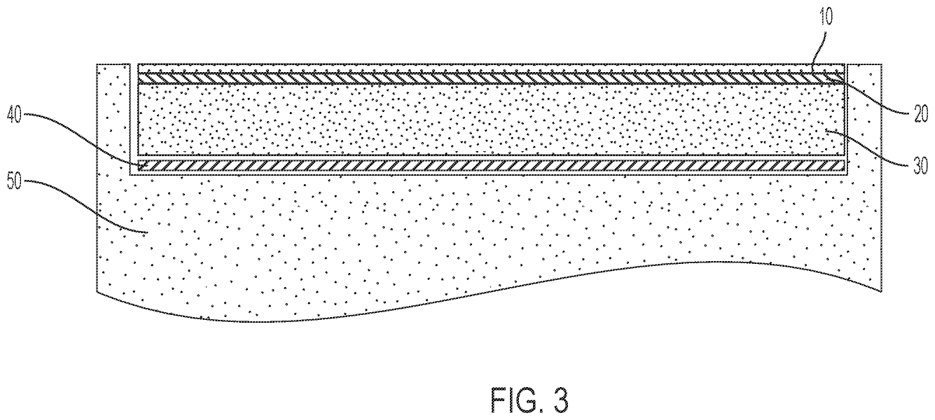

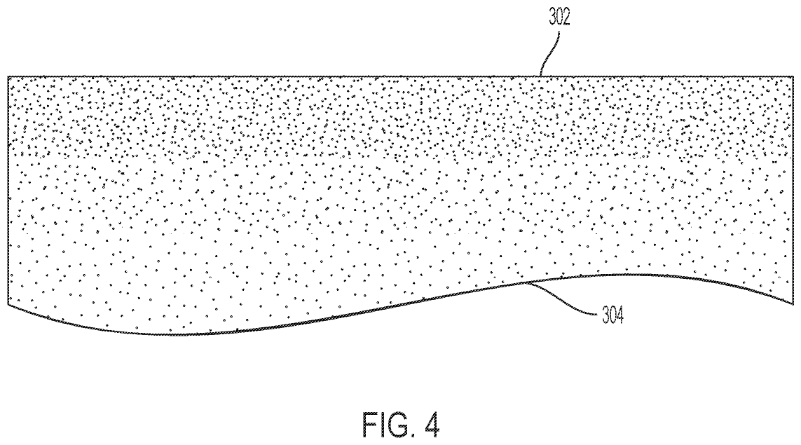

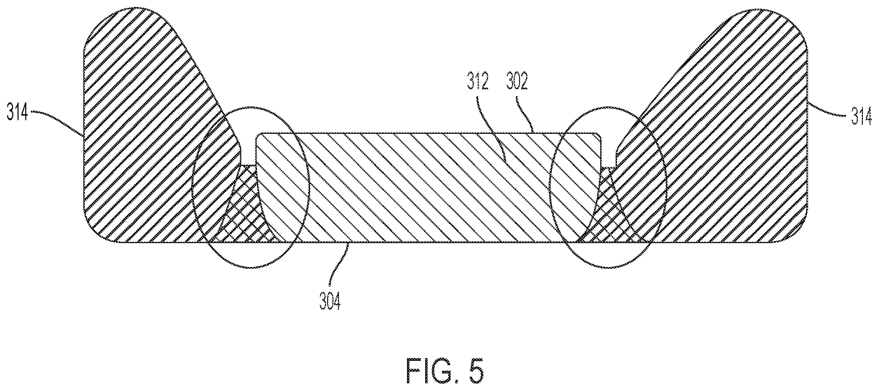

Unlike conventional systems such as the topper pad shown in FIG. 3, which may include multiple layers (e.g., fleece cover/polyester web 10, cover/web glue 20, topper foam 30, foam glue 40, seat foam 50) each having their own manufacturing and assembly process the gradient foam cushion 300 shown in FIGS. 2 and 4-6, for example, is a unitary, monolithic, integral, single, and/or solitary foam section having a continuous hardness gradient from the first surface 302 to the second surface 304. In other words, there are no appreciable designed gaps, divisions, discontinuities between the first surface 302 and second surface 304 such that portions of the foam cushion are separated without destroying the foam. It should be understood that foams by nature have cells encapsulating gaps. The cells are an opened or closed structure. Thus, irregularities and the inherent cell structure are permitted and not considered discontinuities that would render the foam not unitary, monolithic, integral, single and/or a solitary foam section. For example, as long as the foam is a continuous polymeric network forming an integral piece it should be suitable.

In other words, the gradient foam cushion is a single piece and not discrete multiple foam pieces arranged together. For example, certain types of conventional seat assemblies may include a separate foam topper pad that is softer and less dense than the primary seat cushion. The topper pad is then fixed to the foam cushion such as by glue. However, the glue results in the formation of a hard zone between the softer topper pad and the harder cushion. The hard zone formed by the glue is harder than both the topper pad and the cushion. In an embodiment, of the gradient foam cushion 300 there are no such intermediate hard zones such that it provides a smooth transition from a soft foam portion to a harder foam portion. In other words, the hardness should be the least, near the first surface 302 and the greatest, near the second surface 304 with all intermediate portions therebetween. For example, gluing multiple foam pieces together would create an intermediate hardness zone at the interface of the foam pieces such that it would interrupt or deviate from a continuous gradient from the first surface 302 to the second surface 304.

A continuous gradient refers to a hardness and/or density that is generally continually increasing from the first surface 302 to the second surface 304, (i.e., continuously decreasing from the second surface 304 to the first surface 302). Accordingly, any foam sample closer to the first surface 302 will have a lower hardness and/or density than an equivalent sample taken further from the first surface 302 (i.e., any sample taken closer to the second surface 304 will have a greater hardness and/or density than an equivalent sample taken further from the second surface 304).

Referring to the embodiment of FIG. 2, the gradient foam cushion 300 includes a first zone/region/segment/portion/volume 306, a second zone/region/segment/portion/volume 308, and a third zone/region/segment/portion/volume 310. Hereinafter it will be described as a zone although it should be understood that it may also be referred to as a region, segment, portion, and/or volume.

In one or more embodiments, the first zone 306 is adjacent the first surface 302 and the third zone 310 is adjacent the second surface 304. In a refinement, the second zone 308 is disposed between the first and third zones 306, 310. In a variation, the gradient foam cushion 300 has a thickness from the first surface 302 to the second surface 304 that is 10 to 350 mm, or even more preferably 25 to 250 mm, or even more preferably 50 to 175 mm. In some embodiments, the first zone 306 has a lower hardness and/or density than the second zone 308, which has a lower hardness and/or density than the third zone 310.

In one or more embodiments, each zone is 20 to 45% of the total volume and/or thickness of the foam cushion 300, or more preferably at least 25 to 40%, or even more preferably at least 30 to 35%. In a refinement, each zone has a uniform volume/thickness. For example, each zone is approximately 33% of the volume of the gradient foam cushion 300. In yet another example, each zone has a thickness of approximately 33.33 mm when the gradient foam cushion 300 is 100 mm thick. In a refinement, each zone is 10 and 80 mm, or more preferably 20 to 65 mm, more even more preferably 30 to 55 mm thick. In another refinement, each zone is 10 and 40 mm thick. In some variations, each zone has a different thickness and/or volume such that it is not uniform. It should be understood that gradient foam cushions having lesser thicknesses are possible however, the differences and effects described herein may be or appear less prevalent than in cushions having a thickness of, for example, at least 30 mm. For example, in a cushion having a total thickness of 30 mm, the first zone (e.g., approximately 10 mm) has a hardness of no more than 3.5 kPa, the third zone has a hardness of at least 5 kPa, and the second zone has a hardness therebetween.

It should be understood that the foam cushion or seat bottom 104 has foam sections without a gradient. For example, the gradient foam cushion 300 for a seat bottom 104 has a gradient hardness/density portion 312 and bolster portions 314 extending from the sides 305 (or being disposed adjacent to the sides 305) as shown in FIG. 3. In at least certain embodiments, the bolster portions 314 do not have a gradient. In other embodiments, the bolster portions 314 have a gradient. For example, the bolster has a gradient as described herein. The gradient is the same or different than the gradient foam cushion 300. In a refinement, the bolster portions have a hardness equivalent to the third zone 310 or greater than the third zone. For example, the bolster portions have a hardness of at least 7.5 kPa, or more preferably at least 8.5 kPa, or even more preferably at least 10.0 kPa, or still even more preferably at least 12.0 kPa according to ISO 3386-1.

In some embodiments, the first zone 306 and third zone 310 have a difference in hardness (i.e., A hardness or hardness delta) of at least 0.5 kPa, or more preferably at least 1 kPa, more even more preferably at least 3 kPa, or still more preferably at least 4 kPa according to ISO 3386-1. In a variation, the difference in hardness is 0.5 to 10 kPa, or more preferable 1 to 7 kPa, or even more preferably 3 to 5 kPa according to ISO 3386-1. In a variation, the first zone 306 and third zone 310 define a difference in density of at least 5.0 kg/m³, or even more preferably at least 7.5 kg/m³, or even yet more preferably 10.0 kg/m³ according to ISO 845.

In one or more embodiments, the first zone 306 has a hardness of no more than 5.0 kPa, or more preferably no more than 4.5 kPa, or even more preferably no more than 4.0 kPa according to ISO 3386-1. In a variation, the first zone 306 has a hardness of 1.0 to 5.0 kPa, or more preferably 2.5 to 4.5 kPa, or even more preferably 3.0 to 4.0 kPa according to ISO 3386-1. In a refinement, the first zone 306 has a density of no more than 66.0 kg/m³, or more preferably no more than 65.0 kg/m³, or even more preferably no more than 64.0 kg/m³ according to ISO 845. For example, the density is 60.0 to 66.0 kg/m³, or more preferably 61.0 to 65.0 kg/m³, or even more preferably 62.0 to 64.0 kg/m³ according to ISO 845.

In some variations, the second zone has a hardness between the first zone 306 and the third zone 310. For example, the second zone 308 has a hardness of at least 4.0 kPa, or more preferably at least 4.5 kPa, or even more preferably at least 5.0 kPa according to ISO 3386-1. In a refinement, the second zone 308 has a hardness of no more than 9.0 kPa, or no more than 8.0 kPa, or more preferably no more than 7.5 kPa, or even more preferably no more than 7.0 kPa according to ISO 3386-1, and still even more preferably no more than 6.0 kPa. In a variation, the second zone 308 has a density of no more than 71.0 kg/m³, or more preferably no more than 70.0 kg/m³, or even more preferably no more than 69.0 kg/m³ and/or at least 64.0 kg/m³, or more preferably at least 65.0 kg/m³, or even more preferably at least 66.0 kg/m³ according to ISO 845.

In one or more embodiments, the third zone 310 has a hardness of at least 7.0 kPa, or more preferably at least 7.5 kPa, or even more preferably at least 8.0 kPa according to ISO 3386-1. In a variation, the third zone 310 has a hardness of 6.5 to 12.0 kPa, or more preferably 7.0 to 10.0 kPa, or even more preferably 7.5 to 8.5 kPa according to ISO 3386-1. In a refinement, the third zone 306 has a density of at least 69.0 kg/m³, or more preferably at least 72.0 kg/m³, or even more preferably at least 74.0 kg/m³ according to ISO 845. For example, the density is 69.0 to 81.0 kg/m³, or more preferably 72.0 to 78.0 kg/m³, or even more preferably 74.0 to 76.0 kg/m³ according to ISO 845.

In one or more embodiments, the gradient foam cushion 300 has an overall density of no more than 70 kg/m³, or more preferably no more than 65 kg/m³, or even more preferably no more than 60 kg/m³. For example, the overall density is 50 to 75 kg/m³, or more preferably 55 to 70 kg/m³, or even more preferably 60 to 65 kg/m³.

It should be understood that because of the nature of a continuous gradient, the cushion may be defined as having, for example, 4, 5, 10, or 20 zones with each zone increasing in hardness and/or density further from the first surface 302 and closer to the second surface 304. In other words, in various embodiments, any sandwiched zone is harder and/or denser than a first adjacent zone that is more proximate to the first surface 302 and less hard and/or less dense than a second adjacent zone that is more proximate to the second surface 304. In some variations, the first zone, most proximate to the first surface 302, has the lowest hardness and/or density and/or the last zone, most proximate to the second surface 304, has the highest hardness and/or density.

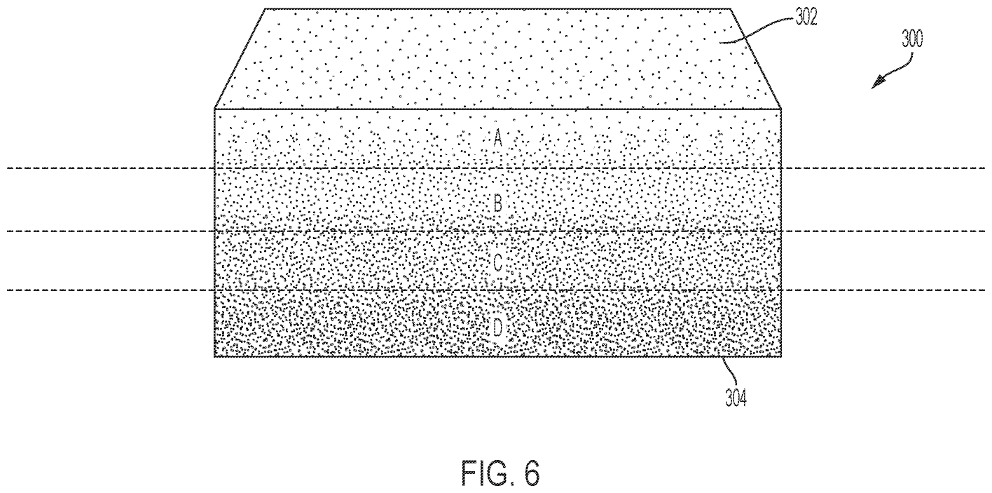

Alternatively, or in combination, the gradient may be represented by the deflection, as shown in FIG. 6. For example, the deflection of the first zone 306 is greater than the second zone 308 which is greater than the third zone 310 (i.e., the deflection of the third zone is less than the second zone which is less than the first zone).

In another example, the difference in deflection (i.e., A deflection or deflection delta) between the first zone 306 and the third zone 310 is at least 10%, more preferably at least 20%, even more preferably at least 25%, or still more preferably at least 30% at a stress of 5 kPa according to ASTM D3574. In some variations, the difference in deflection between the first zone 306 and the third zone 310 at 10 kPa is at least 11%, or more preferably at least 13%, or even more preferably at least 15% according to ASTM D3574. In a refinement, the difference in deflection at 15 kPa between the first zone 306 and the third zone 310 is at least 6%, or more preferably at least 7.5%, or even more preferably at least 9%. In various embodiments, the first zone 306 has the lowest deflection, the third zone 310 has the highest deflection and the second zone 308 has a deflection therebetween.

For example, at a stress of 5 kPa, the first zone 306 has a deflection of greater than 40%, the third zone 310 has deflection of less than 20%, and the second zone 308 has a deflection therebetween (e.g., approximately 10-30%) according to ASTM D3574. At a stress of 10 kPa, the first zone 306 has deflection of greater than 60%, while the third zone 310 has a deflection of less than 60% and the second zone 308 is approximately 60% according to ASTM D3574.

In some embodiment, the gradient foam cushion 300 has a hysteresis energy loss of at least 15%, or more preferably at least 17%, or even more preferably at least 23.5%, or still more preferably at least 25%, or even at least 28% according to ASTM D3574-17 test N using procedure B with a sample having a thickness of 90-100 mm. Whereas, a conventional polyurethane foam cushion without a gradient has a hysteresis energy loss less than 15%, 17%, or 23.5%. In other words, the gradient foam cushion 300 has a greater ability to absorb energy and therefore is more comfortable than the conventional foam cushions. In a refinement, the first zone has a hysteresis loss at least 19%, or more preferably at least 19.5%, or even more preferably at least 20% according to ISO 3386. For example, the first zone has a hysteresis loss of at least 20.4% according to ISO 3386.

In one or more embodiments, the gradient foam cushion feels softer while maintaining greater long-term comfort, for example, when traveling long distance. The softer portion proximate to an occupant gives the effect of softness but the support of harder foams. For example, on conventional soft cushions, an occupant will continually sink during a long trip until the occupant is supported by the harder surfaces such as the seat frame. With a gradient foam cushion 300, an occupant will sink over time through the softer portions until they reach a foam portion with a strength, hardness, and/or density to support them. Accordingly, the occupant is never supported merely by the components beneath the foam such as the seat frame—even during long trips or extended use.

In various embodiments, the gradient foam cushion 300 is more environmentally friendly or sustainable because less components such as glue layers are needed. The aggregate impact of manufacturing, transporting, and assembling the various components (e.g., polyester webbing, topper pads, glue layers, etc.) of conventional assemblies increases the carbon footprint of such technologies. Further, glues or similar technologies often release volatile components directly into the environment during manufacturing and assembly. The single and unitary foam cushion described herein require less manufacturing, transportation, and assembly. In summary, the gradient foam cushion 300 reduces the overall carbon footprint, is more environmentally friendly and/or more sustainable than conventional technologies.

In certain variations, the gradient foam cushion 300 improves manufacturing efficiency and/or reduces cost because additional steps, and materials of assembling and fixing multiple foam pieces or layers together is not necessary. Instead, the gradient foam cushion is assembled in the seat assembly in a single step.

In various embodiments, the trim cover 400 is disposed over the foam cushion 300 and/or the seat frame 200. In a refinement, the trim cover 400 is configured to contact the occupant. For example, the trim cover 400 is made of leather, faux leather, polyurethane, and/or polyester.

In another embodiment, a method 500 of making a seat assembly having a gradient foam cushion is disclosed. The method includes providing a mixture of reactants capable of reacting to form a gradient foam cushion (i.e., step 510), dispensing the mixture into a mold or die (i.e., step 520), heating the mixture to achieve a first temperature (i.e., step 530) and maintaining the temperature within a predetermined temperature range (i.e., step 540) for a duration of time until cured to form a gradient foam cushion, removing the gradient foam cushion (i.e., step 550) and assembling the gradient foam cushion in a vehicle seat assembly (i.e., step 560). For example, Huntsman's Rubiflex systems (e.g., Rubiflex HR GH) are used.

In some variations, the reactants are mixed as they are dispensed into the mixture to mitigate pot-life issues. Alternatively, a blocking mechanism may be used such that the reactants do not react until unblocked. In a refinement, the mixture is added to the mold or die in a pattern to provide a more uniform gradient from the first surface to the second surface.

In some embodiments, the mold or die is heated to achieve a first temperature activating the foaming reaction. In a refinement, the reactants are heated as they are injected or poured into the mold or die. In various embodiments, the temperature of the mold or die is measured, heated, and/or cooled to maintain the temperature within a predetermined temperature range such as between 45 and 70° C., or more preferably 55 and 68° C., or even more preferably 60 and 65° C. In a variation, the temperature is maintained within the predetermined temperature range for a duration of time such that the foam cures to form a gradient foam cushion within the mold.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A seat assembly for a vehicle comprising:
a trim cover configured to contact an occupant;
a gradient foam cushion comprising a first surface proximate to the trim cover and a second surface opposite the first surface, the gradient foam cushion comprising a first zone, a second zone, and a third zone between the first and second surfaces such that the first zone is adjacent to the first surface and the third zone is adjacent to the second surface with the second zone sandwiched between the first and third zones, wherein the first zone has a lower hardness than the second zone and the second zone has a lower hardness than the third zone.

2. The seat assembly of claim 1, wherein the foam cushion has a hardness delta between the first zone and the third zone of at least 0.5 kPa according to ISO 3386-1.

3. The seat assembly of claim 2, wherein the hardness of the first zone is no more than 5.0 kPa according to ISO 3386-1.

4. The seat assembly of claim 3, wherein the hardness of the third zone is at least 7.0 kPa according to ISO 3386-1.

5. The seat assembly of claim 4, wherein the hardness of the second zone of at least 4.0 kPa and no more than 8.0 kPa according to ISO 3386-1.

6. The seat assembly of claim 1, wherein the first zone has a first deflection, the second zone has a second deflection that is less than the first deflection and the third zone has a third deflection that is less than the second deflection.

7. The seat assembly of claim 6, wherein the first zone and the third zone have a difference in deflection of at least 20% at a stress of 5 kPa according to ASTM D3574.

8. The seat assembly of claim 7, wherein the first zone has a deflection of greater than 40% at 5 kPa according to ASTM D3574.

9. The seat assembly of claim 1, wherein the first zone has a deflection of greater than 60% and the third zone has a deflection of less than 60% at 10 kPa according to ASTM D3574.

10. The seat assembly of claim 7, wherein the gradient foam cushion has a hysteresis of at least 23.5% according to ASTM D3574-17 test N using procedure B.

11. The seat assembly of claim 1, wherein the foam cushion is an integral polyurethane foam.

12. A seat assembly comprising:
a frame;
a cushion supported by the frame and comprising a continuous density gradient from a first end to a second end such that the first end has a lower density than the second end, the first end being arranged more proximate to an occupant than the second end;
a trim cover disposed over the cushion and frame.

13. The seat assembly of claim 12, wherein the continuous density gradient is defined by a difference of at least 5.0 kg/m³ according to ISO 845.

14. The seat assembly of claim 12, wherein the continuous density gradient is defined by a difference of at least 7.5 kg/m³.

15. The seat assembly of claim 12, wherein the cushion has a first volume adjacent to a first surface comprising a density of 60.0 to 66.0 kg/m³, a second volume adjacent to the first volume comprising a density of 64.0 to 71.0 kg/m³, and a third volume adjacent to a second surface opposite the first surface comprising a density of 69 to 81 kg/m³, the second volume being sandwiched between the first and third volumes according to ISO 845.

16. A vehicle pad comprising:
a monolithic polyurethane foam cushion comprising a first region, second region and third region wherein the third region has a higher hardness than the second region and the second region has a higher hardness than the first region, the first region being arranged more proximate to an occupant when seated and the second region being sandwiched between the first and third regions.

17. The vehicle seat pad of claim 16, wherein the first region has a hardness of no more than 5.0 kPa.

18. The vehicle seat pad of claim 17, wherein the third region has a hardness of at least 7.0 kPa.

19. The vehicle seat pad of claim 18, wherein each region is between 10 and 80 mm.

20. The vehicle seat pad of claim 19, wherein the first region and the third region have a difference in deflection of at least 10% at a stress of 5 kPa according to ASTM D3574.
